(19) United States
(12) Patent Application Publication
(10) Pub. No.: US 2012/0254309 A1
(43) Pub. Date: Oct. 4, 2012

(54) INFORMATION PROCESSING APPARATUS AND METHOD, ELECTRONIC DEVICE AND CONTROL METHOD THEREOF, AND LOG COLLECTION SYSTEM

(75) Inventor: Mamoru Tokashiki, Tokyo (JP)

(73) Assignee: Sony Corporation, Tokyo (JP)

(21) Appl. No.: 13/426,820

(22) Filed: Mar. 22, 2012

(30) Foreign Application Priority Data
Mar. 29, 2011 (JP) 2011-073043

(51) Int. Cl. G06F 15/16

(52) U.S. Cl. 709/204

(57) ABSTRACT

Methods and apparatus for instructing changes relating to log data collection via a network associated with a plurality of terminals. One exemplary embodiment is directed to an apparatus comprising a communication unit, at least one memory to store processor-executable instructions, and a processing unit communicatively coupled to the communication unit and the at least one memory. Upon execution of the processor-executable instructions by the processing unit, the processing unit determines that a parameter setting for log data collection should be changed for a first terminal of the plurality of terminals. In response to receiving a signal from the first terminal at the communication unit, the processing unit controls the communication unit to transmit instruction data to the first terminal to change the parameter setting for log data collection.

### BACKGROUND

The present disclosure relates to an information processing apparatus and a method, an electronic device and a control method thereof, and a log collection system, and particularly to an information processing apparatus and a method, an electronic device and a control method thereof, and a log collection system capable of efficiently collecting logs in accordance with a purpose.

In the related art, logs are collected in various electronic devices and the like.

By collecting and analyzing the logs, it is possible to know the actual state of use of a device and appropriately allocate resources. In addition, it is also possible to use the collected logs for analyzing the preferences, the lifestyle, and the like of the user of the device.

Generally, when performing log analysis, the logs are normally analyzed after collecting as many logs as possible. In addition, a system which collects the logs and a system which analyzes the collected logs are generally systems which are independent from each other.

For example, the log collection is performed by a cooperation system by a server client, and it is necessary to design the system by sufficiently examining a recording scheme, database, a communication protocol, timing of the log collection, and the like. On the other hand, it is necessary to design the system for the log analysis by sufficiently examining the analysis scheme for the log data such as a data mining method or the like.

As described above, the system which collects the logs and the system which analyzes the collected logs are generally designed based on different schemes and are systems which are independent from each other in the related art.

In addition, a log collecting and analyzing system has also been proposed in which a result of the log analysis is fed back and can be used for developing games, for example, by transmitting the logs collected by a log collection terminal to a log server and storing and analyzing the logs at the log server (Japanese Unexamined Patent Application Publication No. 2003-058395).

### SUMMARY

When the data amount of the log data increases, however, it takes time to process the data, and it becomes difficult to complete the desired analysis within a unit of time. In addition, the increased amount of data increases the costs for maintaining and managing the data.

Moreover, since the logs which can be collected from each device are uniformly collected according to the log collection in the related art, the burden for collecting logs is placed on all the users. For example, the burdens such as battery consumption of a device, security risks, and the like are placed on the users.

In addition, according to the log collection in the related art, for example, there are cases where it becomes necessary to add log content which has previously not been considered, or adjustment becomes necessary between the many persons involved when it is necessary to increase the frequency of the log collection. For example, when it becomes necessary to add information, which has not yet been transmitted, to the log data for the log analysis, it is necessary to change an application program and the like mounted on each device. Alternatively, when it becomes necessary to change the frequency of transmitting the log data from each device to the log collecting server, it is still necessary to change the application program and the like mounted on the device.

Then, it is necessary to mount the changed application program and the like again on multiple devices. In the related art, the addition of functions relating to the log collection and the like is performed in accordance with the timing of the upgrading of the application program of the device, for example. When the log analysis is performed for the purpose of marketing or the like, however, speed is an important factor. For example, if the log analysis for the purpose of marketing in an event for a limited time only is not completed within the period, the analysis does not have any meaning.

Moreover, since the system relating to the log collection and the system relating to the log analysis employ systems which are independent from each other, for example, adjustment for the addition of the log content, the change in the frequency of the log collection, and the like tend to become more complicated.

It is desirable to make it possible to effectively perform the log collection in accordance with the purpose.

One exemplary embodiment described herein is directed to an apparatus for instructing changes relating to log data collection via a network associated with a plurality of terminals. The apparatus comprises a communication unit, at least one memory to store processor-executable instructions, and a processing unit communicatively coupled to the communication unit and the at least one memory. Upon execution of the processor-executable instructions by the processing unit, the processing unit determines that a parameter setting for log data collection should be changed for a first terminal of the plurality of terminals. In response to receiving a signal from the first terminal at the communication unit, the processing unit controls the communication unit to transmit instruction data to the first terminal to change the parameter setting for log data collection.

Another exemplary embodiment described herein is directed to a method of instructing changes relating to log data collection via a network associated with a plurality of terminals. The method comprises determining that a parameter setting for log data collection should be changed for a first terminal of the plurality of terminals, electronically receiving a signal from the first terminal, and in response to electronically receiving the signal, electronically transmitting instruction data to the first terminal to change the parameter setting for log data collection.

A further exemplary embodiment described herein is directed to at least one computer-readable medium. The at least one computer-readable medium is encoded with instructions that, when executed on at least one processing unit, cause an apparatus to determine that a parameter setting for log data collection should be changed for a first terminal of a plurality of terminals, electronically receive a signal from the first terminal, and in response to electronically receiving the signal, electronically transmit instruction data to the first terminal to change the parameter setting for log data collection.

Another exemplary embodiment described herein is directed to an apparatus for receiving instructions relating to log data collection via a network associated with a server. The apparatus comprises a communication unit, at least one memory to store processor-executable instructions, and a processing unit communicatively coupled to the communication unit and the at least one memory. Upon execution of the processor-executable instructions by the processing unit, the processing unit controls the communication unit to transmit a signal to the server. In response to receiving a response to the signal, the response comprising instruction data to change a parameter setting for log data collection, the processing unit changes the parameter setting for log data collection.

### BRIEF DESCRIPTION OF THE DRAWINGS

FIG. 1 is a diagram illustrating an example of a scheme for log collection and log analysis;

FIG. 2 is a diagram illustrating a scheme for log collection and log analysis according to this technique;

FIG. 3 is a diagram showing a configuration example of a log collection system according to this technique;

FIG. 4 is a block diagram showing a configuration example of the terminal in FIG. 3;

FIG. 5 is a block diagram showing a configuration example of the log collection server in FIG. 3;

FIG. 6 is a block diagram showing a functional configuration example of software such as a program executed by the CPU in FIG. 4;

FIG. 7 is a block diagram showing a functional configuration example of software such as a program executed by the CPU in FIG. 5;

FIG. 8 is a diagram showing an example of log data transmitted from a terminal;

FIG. 9 is a diagram showing an example of data stored on database of a log collection server;

FIG. 10 is a diagram showing an example of another data stored in database of a log collection server;

FIG. 11 is a diagram showing an example of a screen displayed on a display of a log analysis apparatus;

FIG. 12 is a diagram showing an example of a GUI with which a change in a parameter setting is designated corresponding to FIG. 11;

FIG. 13 is a diagram showing an example of instruction data;

FIG. 14 is a diagram showing another example of a screen displayed on a display of a log analysis apparatus;

FIG. 15 is a diagram showing another example of instruction data;

FIG. 16 is a flowchart for illustrating an example of log transmission processing; and

FIG. 17 is a flowchart for illustrating an example of polling response processing.

### DETAILED DESCRIPTION OF EMBODIMENTS

Hereinafter, description will be given of an embodiment of the technique disclosed herein with reference to the drawings.

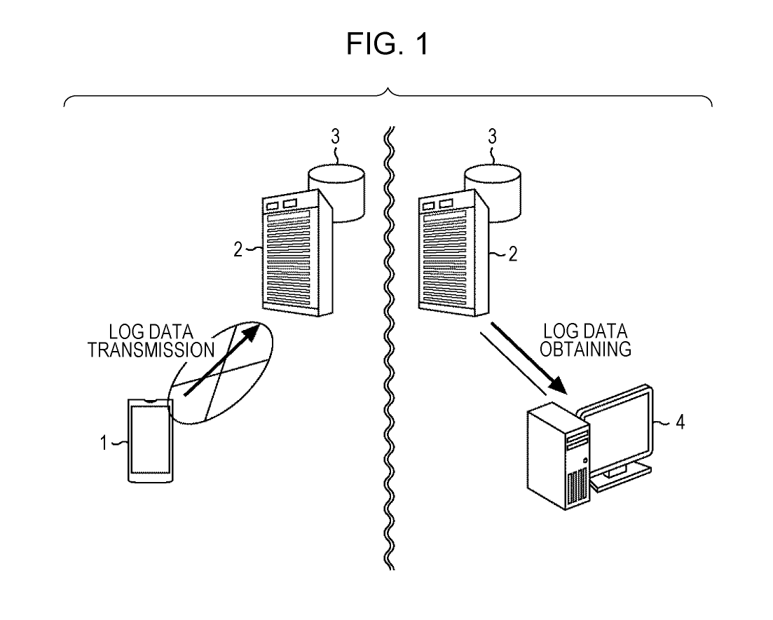

FIG. 1 is a diagram showing a scheme for log collection and log analysis. In the example shown in the drawing, log data is transmitted from the log collection target terminal (for example, a smart phone) 1 to a log collection server 2. Then, log analysis apparatus 4 obtains log data from a log collection server and analyzes the logs.

A smart phone 1 as a log collection target terminal accesses a base station in a wireless manner, for example, and then performs communication with the log collection server 2 via a network such as the Internet. The wireless communication is performed with the use of the mobile communication network used by a mobile phone, for example.

The smart phone 1 includes a display with a function as an operation unit by a GUI, for example, and is capable of accessing a predetermined web page via the Internet and displaying the information of the web page on the display. In addition, when the user has not input an operation for a predetermined time period or longer, for example, the display on the display of the smart phone 1 is automatically locked, and the smart phone 1 is operated in a power saving mode after the locking. The user can release the lock of the smart phone 1 by inputting a registered password or the like as well as a predetermined operation (touching the display, for example) set in advance.

In addition, it is also possible to automatically access a desired web page at a desired time and cause a display to display the information of the web page by the user of the smart phone 1 registering the time and the URL (Uniform Resource Locator) in advance. That is, it is also possible to automatically display the information of a web page on the display in accordance with the time at which the lock is released in the smart phone 1. For example, setting can be made such that a train situation is automatically displayed on the display of the smart phone 1 if the lock is released from 7 am to 8 am, and news is automatically displayed on the display of the smart phone 1 if the lock is released from 9 am to 10 am.

The log data transmitted from the log collection target terminal (smart phone) 1 includes information such as the time at which the lock of the smart phone 1 is released by the user, the web page displayed at that time, and the like, for example.

The log data transmitted from the smart phone 1 is accumulated in the database 3 constructed in an external storage apparatus connected to the log collection server 2.

When the log data is analyzed, a person who performs the analysis obtains the log data from the log collection server 2 with the use of the log analysis apparatus 4 configured by a personal computer or the like, for example. The log analysis apparatus 4 accesses the log collection server 2 via a network such as the Internet, for example, and searches for the desired log data in the database 3. The searched log data is obtained by receiving the log data via the network.

Although only one log collection target terminal is shown in the drawing, there are more log collection target terminals in practice.

In this example, the software or the like relating to the log collection shown in the left side in FIG. 1 and the software or the like relating to the log analysis shown in the right side in FIG. 1 are developed based on different schemes.

For example, the software relating to the log collection is developed as a part of an application program or the like mounted on the smart phone 1. By executing this application program, the log data including preset information is transmitted from the smart phone 1 to the log collection server 2 at predetermined time set in advance.

For example, the software relating to the log analysis is developed in accordance with the purpose of the log analysis such as marketing, grasping a use state, or the like such that processing is executed in which the desired information is extracted from the log data accumulated in the database 3 and shown to the person who performs the analysis.

In the log collection and the log analysis according to the above technique shown in the example in FIG. 1, however, the following program can be considered.

For example, each of the multiple log collection target terminals 1 transmits the log data with a uniform information amount to the log collection server 2 at a uniform frequency, according to the technique in this example. Therefore, the amount of log data accumulated in the database 3 becomes huge. If the amount of the log data is large, it takes a long time to process the data, and it becomes difficult to complete the desired analysis in the unit time. In addition, the increased data amount increases the costs for maintaining and managing the data.

Since the logs which can be collected from each device are uniformly collected in many cases according to the log collection by the technique in this example, the burden of the log collection is placed on all users. For example, the burdens such as the battery consumption of the device, security risks, and the like are placed on the users.

Moreover, when it becomes necessary to add log content which has previously not been considered, or when it becomes necessary to increase the frequency of the log collection, for example, in the log collection of this example, adjustment involving multiple users is necessary. For example, when it becomes necessary to add the information which has not yet been transmitted for the log analysis, it is necessary to change an application program and the like mounted on the smart phone 1. In addition, even when it becomes necessary to change the frequency at which the log data is transmitted from the log collection target terminal 1 to the log collection server 2, it is necessary to change the application program and the like mounted on the smart phone 1.

In addition, it is necessary to mount the changed application program and the like again on the multiple log collection target terminals. For example, the addition of functions relating to the log collection and the like is performed in accordance with the timing of the upgrading of the application program of the smart phone 1. When the log analysis is performed for the purpose of marketing or the like, however, speed is an important factor. For example, if the log analysis for the purpose of marketing in an event for a limited time only is not completed within the period, the analysis does not have any meaning.

Moreover, since the system relating to the log collection and the system relating to the log analysis employ systems which are independent from each other, for example, adjustment for the addition of the log content, the change in the frequency of the log collection, and the like tend to become more complicated.

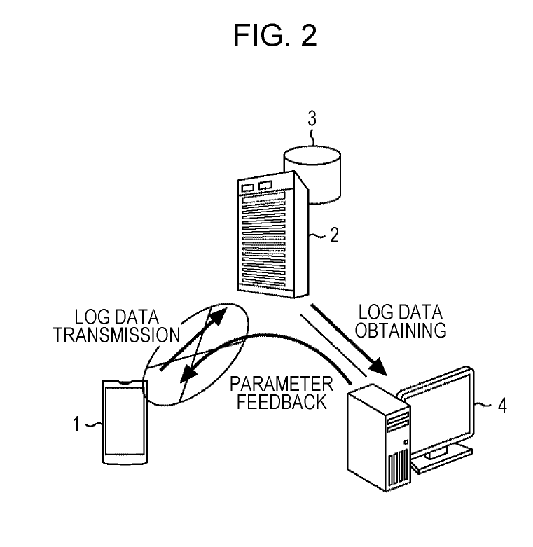

Thus, according to this technique, a parameter is fed back to the log collection target terminal 1 in response to the user of the log analysis apparatus 4 as shown in FIG. 2. For example, the configuration is made such that the information to be included in the log data (log content), the frequency at which the log data is transmitted to the log collection server 2, and the like can be set as parameters and the parameters can be changed in response to the request by the user of the log analysis apparatus 4. In addition, the configuration is made such that the changed parameter can be fed back to all log collection target terminals 1 through the log collection server 2.

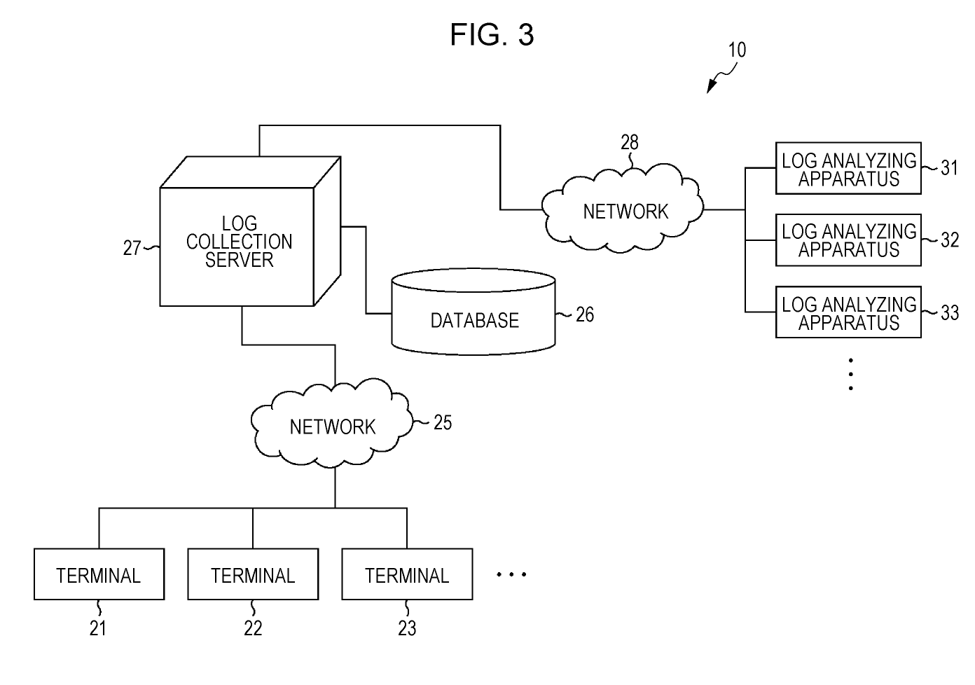

FIG. 3 is a diagram showing a configuration example of the log collection system 10 according to this technique. On a terminal 21, a terminal 22, a terminal 23, . . . as the log collection target terminals, the software and the hardware for the log collection are mounted, and the terminal 21, the terminal 22, the terminal 23, . . . are connected to the network 25, respectively.

Each of the terminal 21, the terminal 22, the terminal 23, . . . is configured by an electronic device such as a personal computer, a mobile phone, a smart phone, or the like, for example. Here, description will be given of a case in which each of the terminal 21, the terminal 22, the terminal 23, . . . is configured as a smart phone. The functions of the smart phone are the same as those in the aforementioned case described with reference to FIG. 1.

That is, the smart phone includes a display with a function of an operation unit by a GUI, for example, and is capable of accessing a predetermined web page via the Internet, for example, and displaying the information of the web page on the display. In addition, when the user has not input an operation for a predetermined time period or longer, for example, the display on the display of the smart phone is automatically locked, and the smart phone is operated in a power saving mode after the locking. The user can release the lock of the smart phone by inputting a registered password or the like as well as a predetermined operation (touching the display, for example) set in advance.

In addition, it is also possible to automatically access a desired web page at a desired time and cause a display to display the information of the web page by the user of the smart phone registering the time and the URL (Uniform Resource Locator) in advance. That is, it is also possible to automatically display the information of a web page on the display in accordance with the time at which the lock is released in the smart phone. For example, setting can be made such that a train situation is automatically displayed on the display of the smart phone if the lock is released from 7 am to 8 am, and news is automatically displayed on the display of the smart phone if the lock is released from 9 am to 10 am.

The log data transmitted from the smart phone includes information such as the time at which the lock of the smart phone is released by the user, the web page displayed at that time, and the like, for example.

The network 25 includes a base station for wireless communication, for example, and a wired network (for example, the Internet) for performing communication thereafter with the log collection server 27.

Each of the terminal 21, the terminal 22, the terminal 23, . . . is configured so as to periodically perform polling with respect to the log collection server 27 and transmit its own identification number or the like in the polling. In addition, a predetermined application program is respectively mounted on each of the terminal 21, the terminal 22, the terminal 23, . . . , and the log data is automatically transmitted to the log collection server 27 by executing this program.

In addition, the application program to be mounted on each of the terminal 21, the terminal 22, the terminal 23, . . . receives the parameter setting based on the data transmitted from the log collection server 27. For example, as the response to the aforementioned polling, data relating to the parameter setting is transmitted from the log collection server 27 to the terminal 21, the terminal 22, the terminal 23, . . . . The data relating to the parameter setting is data described as an XML text, for example.

The log collection server 27 is configured by a computer with a relatively high processing ability and controls processing of writing, reading, and the like of the data in the database 26 constructed in the external storage apparatus configured by an HDD or the like. The log data transmitted from the terminal 21, the terminal 22, the terminal 23, . . . is replaced with a data set in a predetermined format and sequentially stored in the database 26.

In addition, the log collection server 27 is executes the processing of sorting the log data accumulated in the database 26 based on predetermined criteria.

Each of a log analysis apparatus 31, a log analysis apparatus 32, a log analysis apparatus 33, . . . is configured by a personal computer. When the log data is analyzed, the person who performs the analysis obtains the log data from the log collection server 27 with the use of the log analysis apparatus 31, for example. The log analysis apparatus 31 accesses the log collection server 27 via the network 28 such as the Internet or the like, for example, and searches for a desired data set in the database 26. In addition, the network 25 and the network 28 may be the same network.

Then, the person who performs the analysis obtains the log data by receiving the data obtained from the data set, which has been searched as described above, by the log analysis apparatus 31. The log analysis apparatus 31 executes processing of displaying the obtained log data in a graph based on the sorting result of the log data by the log collection server 27, for example.

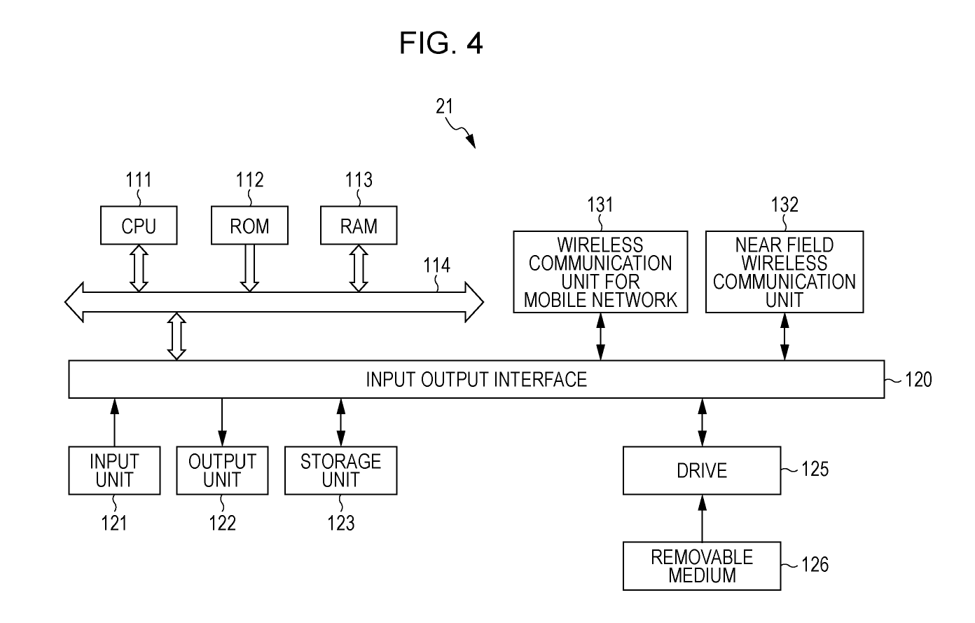

FIG. 4 is a block diagram showing a configuration example of the terminal 21 in FIG. 3. Although FIG. 3 shows the configuration of the terminal 21, it is also possible to apply the configuration in FIG. 3 to the terminal 22, the terminal 23, . . . .

In FIG. 4, the CPU (Central Processing Unit) 111 of the terminal 21 executes various kinds of processing based on the program stored in the ROM (Read Only Memory) 112, or the program loaded from the storage unit 123 to the RAM (Random Access Memory) 113. The RAM 113 appropriately stores data which is necessary for the CPU 111 to execute various kinds of processing.

The CPU 111, the ROM 112, and the RAM 113 are connected to each other via a bus 114. An input output interface 120 is also connected to the bus 114.

To the input output interface 120, an input unit 121 including a keyboard, a mouse, and the like, a display including an LCD (Liquid Crystal Display) and the like, an output unit 122 including a speaker and the like, and a storage unit 123 constituted by a hard disk, a flush memory, and the like are connected.

A drive 125 is also connected, if necessary, to the input output interface 120, and a removable medium 126 such as a magnetic disk, an optical disc, an optical-magnetic disk, a semiconductor memory, or the like is appropriately mounted thereon. The computer program read from the removable medium 126 is installed on the storage unit 123, if necessary.

Moreover, a wireless communication unit 131 for the mobile communication network and a near field wireless communication unit 132 are connected to the input output interface 120.

The wireless communication unit 131 for the mobile communication network is a wireless communication device which performs wireless communication with a wireless base station, which is not shown in the drawing, and performs communication via the mobile communication network. The wireless communication unit 131 for the mobile communication network uses a frequency band of 2 GHz, for example, and is used not only in the telephone call application but also in various communication applications for the internet connection and the like with the use of the data communication of a maximum of 2 Mbps. For example, the wireless communication by the wireless communication unit 131 for the mobile communication network is used for downloading content data, communicating with the server 21, and the like. In addition, it is assumed that the wireless communication unit 131 for the mobile communication network is configured as a device or the like capable of performing communication based on a communication scheme for a so-called third generation mobile phone, for example.

The near field wireless communication unit 132 is a near field wireless communication device such as Bluetooth (registered trademark; also referred to as BT), IEEE (Institute of Electrical and Electronic Engineers) 802.11x, or the like. Here, the near field communication means the local (narrow band) wireless communication with a maximum communicable distance of several meters to several tens of meters. An arbitrary communication standard can be employed. For example, when the near field wireless communication unit 132 is for the communication by the BT, the communication at the maximum communication speed of 3 Mbit/sec (version 2.0+EDR or later) is performed in a band of 2.4 GHz via an antenna.

Each part of the terminal 21 is controlled by the CPU 111. The execution binary code for the control program is stored on the ROM 112 or the storage unit 123, a stack region and the heap region are developed on the RAM 113 for various kinds of computation processing.

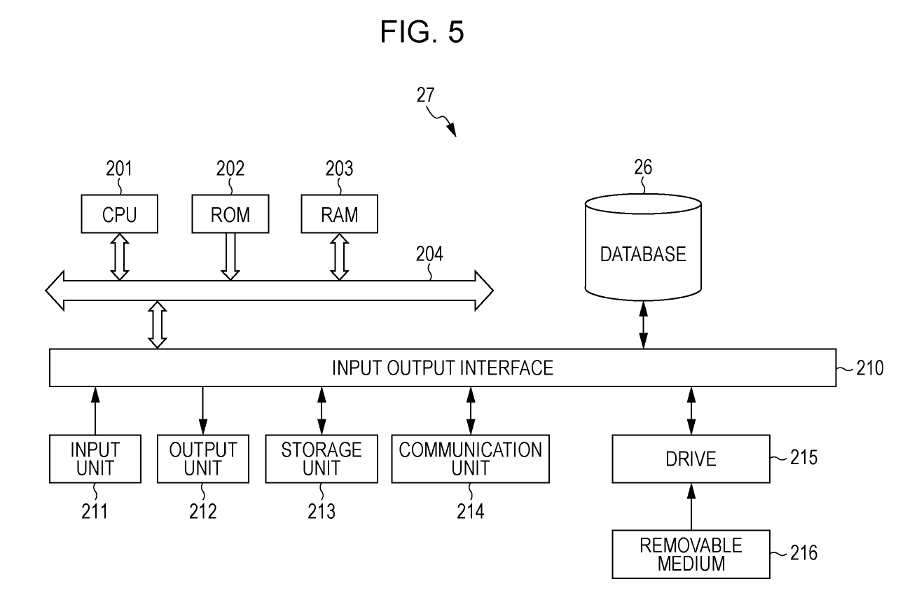

FIG. 5 is a block diagram showing a configuration example of the log collection server 27 in FIG. 3.

As shown in the drawing, the log collection server 27 includes a CPU 201, a ROM 202, and a RAM 203 which are connected to each other via a bus 204 in the same manner as in the case of the terminal 21. In addition, an input output interface 210 is connected to the bus 204.

An input unit 211, an output unit 212, a storage unit 213, and a driver 215 for a removable medium 216 are connected to the input output interface 210 in the same manner as in the case of the terminal 21.

The CPU 201, the ROM 202, the RAM 203, the bus 204, the input output interface 210, the input unit 211, the output unit 212, the storage unit 213, the drive 215, and the removable medium 216 in FIG. 5 correspond to the CPU 111, the ROM 112, the RAM 113, the bus 114, the input output interface 120, the input unit 121, the output unit 122, the storage unit 123, the drive 125, and the removable medium 126 in FIG. 4, respectively.

The log collection server 27 includes a communication unit 214 connected to the input output interface 210. The communication unit 214 is a communication device for the communication with another device via the network. For example, the communication unit 214 is connected to the wired network and used for the communication with the terminal 21, the terminal 22, the terminal 23, . . . , and the log analysis apparatus 31, the log analysis apparatus 32, the log analysis apparatus 33, . . . .

Moreover, the database 26 is connected to the input output interface 210.

The log data transmitted from the terminal 21, the terminal 22, the terminal 23, . . . is replaced with the data set in the predetermined format, for example, as described above and stored in the database 26.

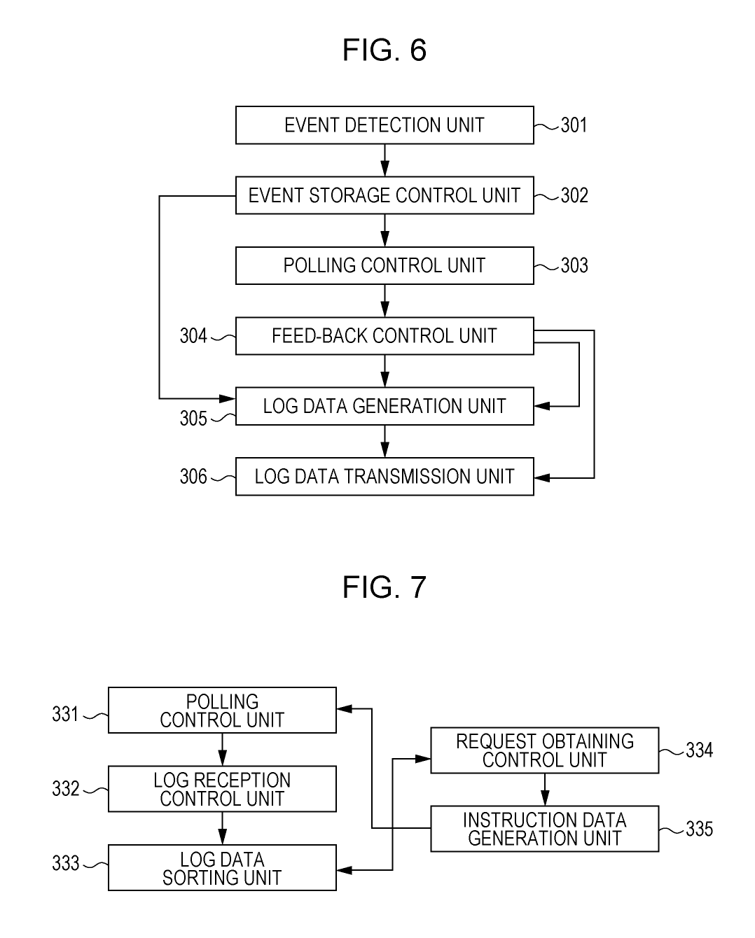

FIG. 6 is a block diagram showing a functional configuration example of the software such as a program to be executed by the CPU 111 of the terminal 21 in FIG. 4.

An event detection unit 301 shown in the drawing detects various events occurring in the terminal 21. For example, the event detection unit 301 detects the display lock or the release of the lock of the display of the terminal 21 as an event. In addition, when the terminal 21 accesses a predetermined web page, for example, the event detection unit 301 detects the access and the URL of the destination of the access as events.

An event recording control unit 302 associates and stores the event detected by the event detection unit 301 with the time at which the event occurs.

A polling control unit 303 controls the polling which the terminal 21 periodically performs on the log collection server 27. In addition, the polling control unit 303 supplies the information relating to the feed-back to the feed-back control unit 304 when the response to the poling from the log collection server 27 includes the feed-back. As described above, the data relating to the parameter setting is transmitted as feed-back from the log collection server 27 to the terminal 21 as the response to the polling.

A feed-back control unit 304 reflects the designated parameter setting by reading the information relating to the feed-back. In so doing, the data described as an XML text is read as the information relating to the feed-back and a parameter is newly set (the setting is changed) based on the description of the XML text.

A log data generation unit 305 generates the log data from the information recorded in the event recording control unit 302 based on the preset parameter. For example, the content of the information to be included in the log data is designated as the parameter, and the log data including the designated information is generated. In addition, when the parameter setting is changed by the feed-back control unit 304, the log data generation unit 305 generates the log data based on the changed parameter.

A log data transmission unit 306 transmits the log data generated by the log data generation unit 305 to the log collection server 27 based on the preset parameter. For example, the frequency (interval) at which the log data is transmitted for each period of time is designated as a parameter, and the log data is transmitted at the designated frequency. When the parameter setting is changed by the feed-back control unit 304, the log data transmission unit 306 generates the log data based on the changed parameter.

FIG. 7 is a block diagram showing a functional configuration example of the software such as a program or the like to be executed by the CPU 201 of the log collection server 27 in FIG. 5.

A polling control unit 331 shown in the drawing receives the polling transmitted from the terminal 21 or the like and controls the processing of transmitting the response to the polling. In addition, the response to the polling transmitted by the polling control unit 331 includes the information relating to the feed-back, if necessary.

The log reception control unit 332 controls the reception of the log data transmitted from the terminal 21 or the like. In addition, the log reception control unit 332 replaces the received log data with the data set in the predetermined format, for example, and causes the database 26 to successively store the data set.

A log data sorting unit 333 sorts the log data received by the log reception control unit 332 based on predetermined criteria. The log data sorting unit 333 sorts the log data based on a clustering method such as a K-means method, for example. For example, the log data received from each terminal is sorted into a plurality of classes (a class of an average number of times, a class of a large number of times, a class of a small number of times, and the like, for example) in accordance with the number of times of the lock release per day of each terminal.

The log data sorting unit 333 sorts the log data based on the control by the request obtaining control unit 334 which will be described later and supplies the sorting result to the request obtaining control unit 334.

The request obtaining control unit 334 obtains the requests from the log analysis apparatus 31, the log analysis apparatus 32, the log analysis apparatus 33, . . . and executes the processing in response to the obtained requests. For example, when the request for searching for the log data is received from the log analysis apparatus 31, the request obtaining control unit 334 searches for the log data stored in the database 26 and sends the search result.

In addition, when the request for changing the parameter setting is received from the log analysis apparatus 31 or the like, the request obtaining control unit 334 generates the information for specifying a parameter to be changed and supplies the information to the instruction data generation unit 335.

The instruction data generation unit 335 generates the instruction data for instructing the terminal 21 to change the parameter setting based on the information supplied from the request obtaining control unit 334, for example. An XML text for designating the change of the parameter setting is generated as instruction data, for example.

In addition, the instruction data generated by the instruction data generation unit is supplied to the polling control unit 331 and transmitted to the terminal 21 or the like as the response to the polling.

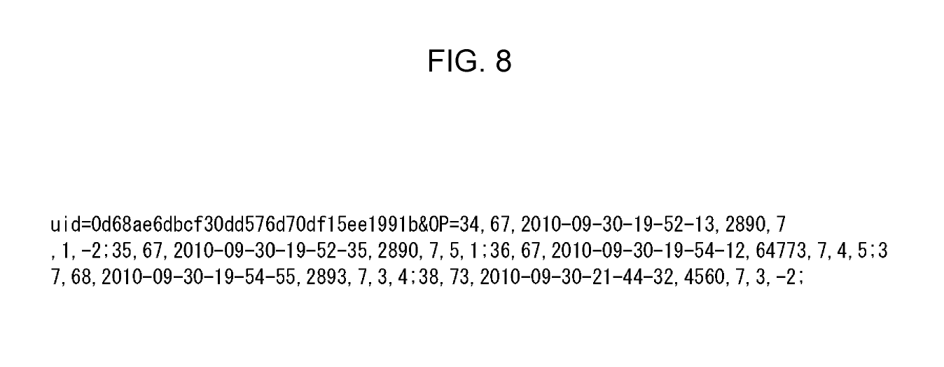

FIG. 8 is a diagram showing an example of the log data transmitted from the terminal 21 or the like. In the example of the drawing, the log data is constructed by data sectioned with semicolons or commas. For example, the format of the log data is set in advance, and the log data generated based on the preset format is transmitted.

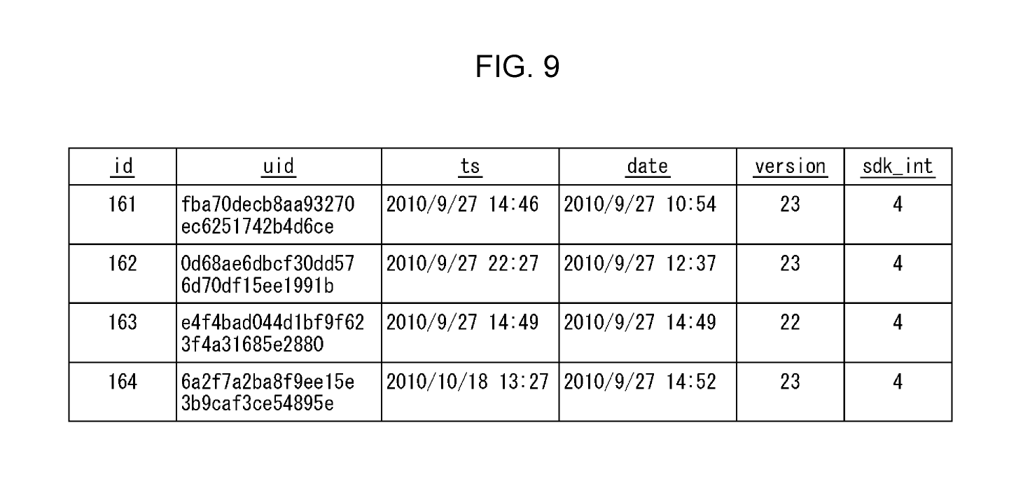

FIG. 9 is a diagram showing an example of the data stored in the database 26 of the log collection server 27. In this example, four (four lines in the drawing) data sets are stored in the database 26. In addition, each data set includes five attributes including “id”, “ts”, “date”, “version”, and “sdk int”.

The “uid” is a unique identification number of each terminal such as the terminal 21, the terminal 22, the terminal 23, . . . . The attribute “id” is obtained by simplifying the identification number described as the attribute “uid”.

The attribute “ts” is a so-called time stamp, and the event occurrence date and time corresponding to the finally transmitted log data is described in each terminal identified by the attribute “id”.

The attribute “date” is the information indicating a so-called registration date and time, and the event occurrence date corresponding to the firstly transmitted log data is described in each terminal identified by the attribute “id”, for example.

The attribute “version” is the information indicating the version of the application program or the like mounted on each terminal.

The attribute “sdk int” is the information indicating the version of the OS (Operating System) mounted on each terminal.

Although the description was given here of the example in which the four data sets are stored, more data sets are stored in practice.

The data shown in FIG. 9 is a so-called terminal information database, which is for easily checking the installation state of a program in each terminal. That is, the terminal information database constructed by the data shown in FIG. 9 is configured by the data including the number of lines corresponding to the number of the terminal which performs the polling on the log collection server 27.

The database described herein is one example of a so-called terminal information database, and terminal information database with different attributes may also be configured. For example, the terminal information database including information such as the age, the sex, the occupation, and the like of the user of each terminal may be configured.

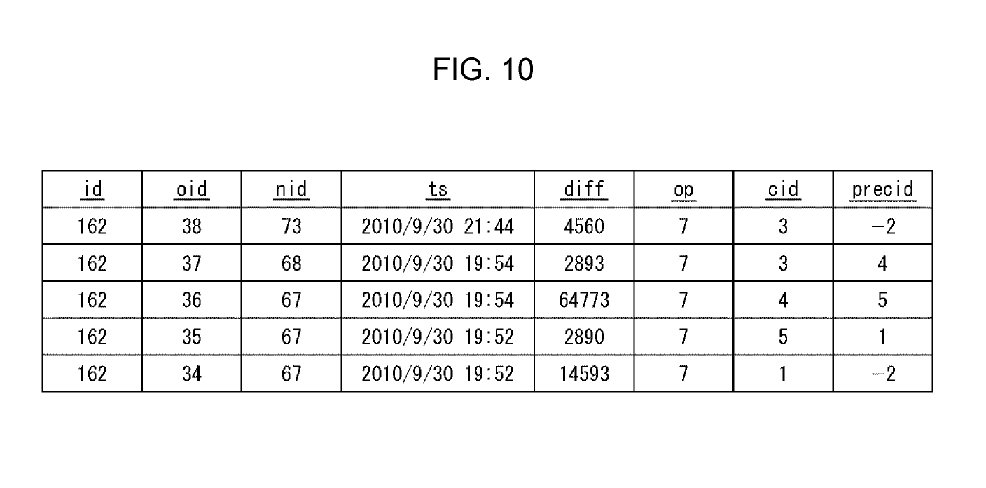

FIG. 10 is a diagram showing an example of different data stored in the database 26 of the log collection server 27. In the case of FIG. 10, the database is configured by the data set including the lines corresponding to the log data transmitted multiple times from each terminal, and the database is a so-called log database.

In this example, five (five lines in the drawing) data sets are stored in the database 26. Then, each data set includes eight attributes including “id”, “oid”, “nid”, “ts”, “diff”, “op”, “cid”, and “precid”.

The attribute “id” is the same as that in the case of FIG. 9.

The attribute “oid” is the unit identification number of the data set.

The attribute “nid” is the number for identifying an event of the log data corresponding to the data set, for example. For example, the information (number) indicating the display lock, the lock release of the display and the like is described.

The attribute “ts” is a so-called time stamp, and the information such as the event occurrence date and time of the log data corresponding to the data set.

The attribute “diff” is the information indicating the event continuation time of the log data corresponding to the data set, for example. For example, the event of the log data corresponding to the data set is the display lock release of the display, the information indicating the time from the lock release to the next lock is described.

The attribute “op” is the information indicating the type of the operation when the event of the log data corresponding to the data set occurs. For example, when the log data corresponding to the data set corresponds to the event in which an operation of touching the display of the terminal is performed to release the display lock of the display, the information (number) indicating the operation of touching the display of the terminal is described in the attribute “op”.

The attribute “cid” is an identification number for specifying the content which is being displayed on the display of the terminal 21 or the like when the event of the log data corresponding to the data set occurs, for example. When the terminal 21 or the like accesses a predetermined web page and displays the information of the web page on the display, for example, the information (number) for specifying the URL of the destination of the access is described in the attribute cid.

The attribute “precid” is the information (number) for specifying the content displayed on the display of the terminal 21 or the like just before the occurrence of the event of the log data corresponding to the data set, for example.

In addition, the attributes shown herein are examples of a so-called log database, and a log database with attributes which are different from the above attributes may be configured. For example, the log database including the information such as the battery consumption state of each terminal, the data amount transmitted and received in a unit time, and the like may be configured. Alternatively, a log database including the information for specifying the current position of each terminal obtained by the GPS function of each terminal may be configured.

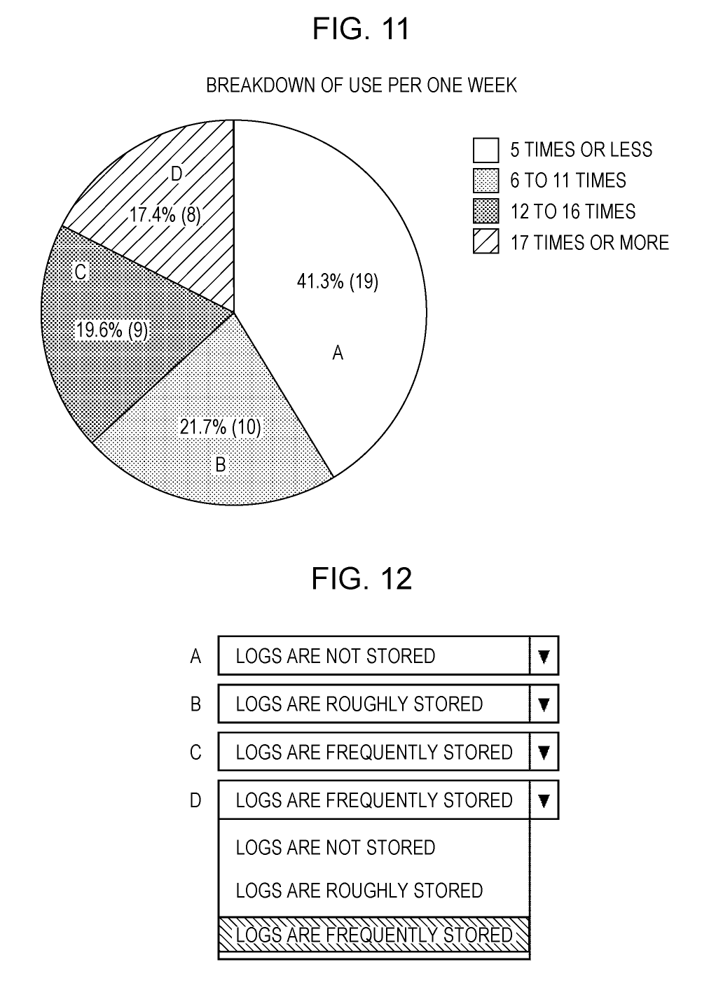

FIG. 11 is a diagram showing an example of the screen displayed on the display of the log analysis apparatus 31 or the like. In this example, the data relating to the frequency of the lock release per week of each terminal is displayed as a circular graph.

It can be understood from the circular graph that the ratio of the terminals in which the number of times of the lock release per week is five or less is 41.3%, the ratio of the terminals in which the number of times of the lock release per week is from six to eleven is 21.7%, the ratio of the terminals in which the number of times of the lock release per week is from twelve to sixteen in 19.6%, and the ratio of the terminals in which the number of times of the lock release per week is 17 or greater is 17.4%. Such sorting of the log data is executed by the log data sorting unit 333 of the log collection server 27, for example.

The person who performs the analysis refers to the screen as shown in FIG. 11, which is displayed on the display of the log analysis apparatus 31 or the like, to grasp the marketing, the use state, and the like.

It is assumed that when the person who performs the analysis, such as a business operator who does marketing on the content, does marketing on predetermined content, the person considers that it is necessary to more frequently perform the log collection for the terminals in which the frequency of the lock release per week is high. In addition, it is assumed that the person considers that it is not necessary to perform the log collection for the terminals in which the number of times of the lock release per week is five or less. In such a case, the person who performs the analysis can cause the display of the log analysis apparatus 31 or the like to display the GUI as shown in FIG. 12 and request the change in the parameter setting so as to change the frequency of the log collection.

In the example of FIG. 12, the GUI with which the change in the parameter setting is designated corresponding to the frequency of the lock release of each terminal shown in the circular graph in FIG. 11, is displayed. In the example of the drawing, a pull-down menu corresponding to the region A to the region D is displayed.

In the example of the drawing, the menu of “logs are not stored” is designated for the log collection of the terminals sorted to the region A. In addition, the menu of “logs are roughly stored (for example, the terminals are made to transmit the logs once per hour)” is designated for the log collection of the terminals sorted to the region B. Moreover, the menu of “logs are frequently stored (for example, the terminals are made to transmit the logs one per thirty minutes)” is designated for the log collection of the terminals sorted to the region C. In addition, the menu of “logs are frequently stored” is designated for the log collection of the terminals sorted to the region D. In the example of FIG. 12, the menu of “logs are frequently stored” is being currently designated in the pull-down menu corresponding to the region D.

It is assumed that protocols and the like are set in advance between the log collection server 27 and the log analysis apparatus 31, the log analysis apparatus 32, the log analysis apparatus 33, . . . for the data transmitted and received for displaying the screen shown in FIG. 11, the screen shown in FIG. 12, and the like. That is, it is assumed that the person who performs the analysis can receive the data from the log collection server 27 and display the screen as shown in FIG. 11 by performing a predetermined operation set in advance in the log analysis apparatus 31 or the like. In addition, it is assumed that the person who performs the analysis can display the screen shown in FIG. 12 and cause the log collection server 27 to change the parameter setting relating to the log collection by performing a predetermined operation set in advance in the log analysis apparatus 31 or the like.

For example, when the change in the parameter setting is requested by the log analysis apparatus 31 in the screen shown in FIG. 12, the request obtaining control unit 334 of the log collection server 27 receives this request. Then, the request obtaining control unit 334 generates the information or the like for specifying the parameter to be changed and supplies the information or the like to the instruction data generation unit 335.

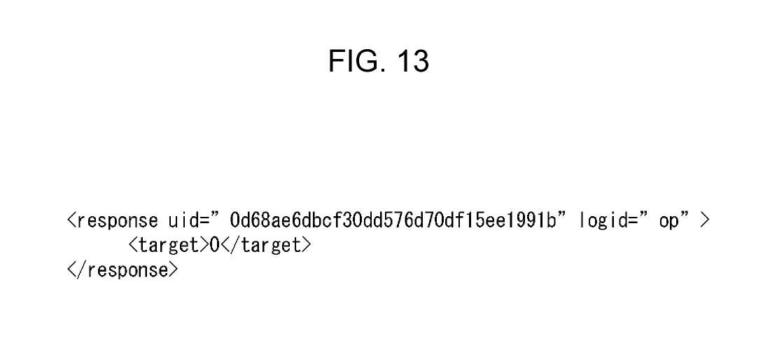

For example, the terminals sorted to the region A are specified by the request obtaining control unit 334, and the information for generating the instruction data which instructs not to store the logs for such terminals is supplied. In so doing, the instruction data as shown in FIG. 13 is generated by the instruction data generation unit 335.

In the example of FIG. 13, an XML text for instructing the change of the parameter setting is generated as the instruction data. The identification number (the attribute “uid” in FIG. 9) of the terminal which transmits this instruction data is designated with the tag described as <response uid=“0d68ae6dbcf30dd576d70df15ee1991b” logid=“op”> in the XML text in the drawing. The instruction data is made to be included in the response to the polling of the terminal corresponding to the designated “uid”.

In addition, the fact that the terminal is not the target of the log collection is designated with the tag described as “<target>0</target>”. In addition, this tag is described as “<target>1</target>” for the instruction data with respect to the terminal as the target of the log collection.

Such instruction data is generated for each of the terminals sorted to the region A by the instruction data generation unit 335. For example, the request obtaining control unit 334 specifies each of the identification numbers of the terminals sorted to the region A, the description of the tag for designating the identification number of the terminal is changed, and the instruction data as shown in FIG. 13 is respectively generated on the basis of the log data sorting unit 333.

In addition, the instruction data in response to the request for the change in the parameter setting from the log analysis apparatus 31 is generated even for each of the terminals sorted to the region B to the region D.

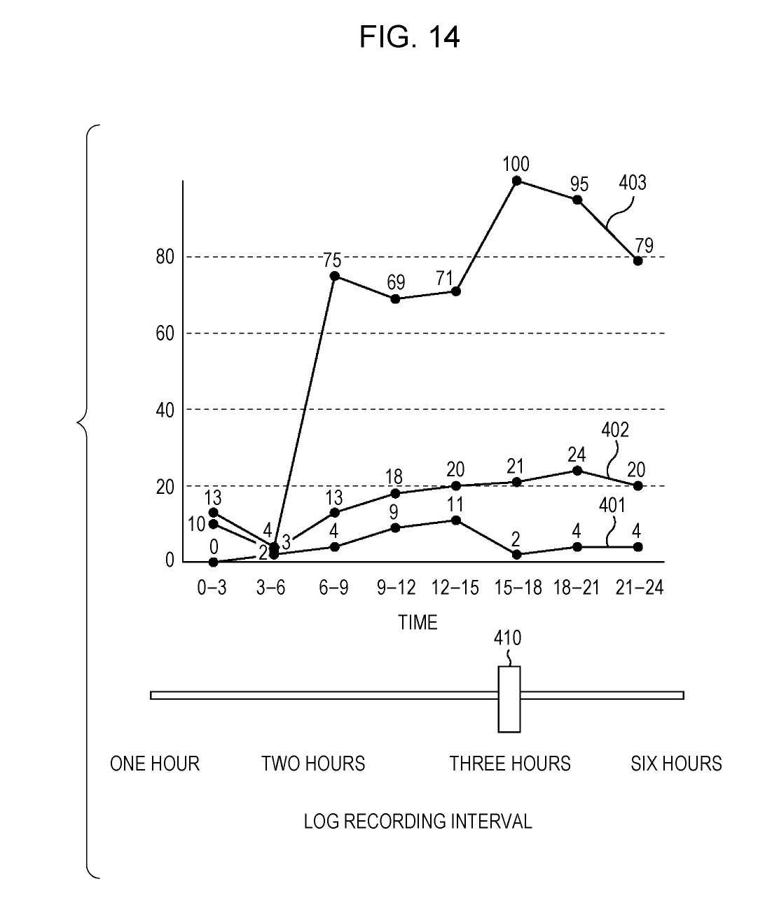

In addition, the person who performs the analysis can display the screen as shown in FIG. 14, for example. In this example, the data relating to the frequency of the lock release in each terminal in each time period is displayed as a line graph. For example, the line 401 in the drawing is obtained by plotting the average value of the number of times of the lock release in each time period of the terminal belonging to the first class sorted based on the number of times of the lock release per week. In addition, the line 402 in the drawing is obtained by plotting the average value of the number of times of the lock release in each time period of the terminal belonging to the second class sorted based on the number of times of the lock release per week. Moreover, the line 403 in the drawing is obtained by plotting the average value of the number of times of the lock release in each time period of the terminal belonging to the third class sorted based on the number of times of the lock release over one week.

In the example of FIG. 14, the change of the number of times of the lock release in the time periods at an interval of three hours including “0 to 3 (from 0 o'clock to 3 o'clock)”, 3 to 6 (from 3 o'clock to 6 o'clock), “6 to 9 (from 6 o'clock to 9 o'clock)”, . . . , “21 to 24 (from 21 o'clock to 24 o'clock)” are shown. The person who performs the analysis can display the number of times of the lock release in the time period at an interval of two hours, the number of times of the lock release in the time period at an interval of six hours, . . . by operating the slider bar 410 in FIG. 14, for example.

The person who performs the analysis can refer to the screen as shown in FIG. 14 displayed on the display of the log analysis apparatus 31 or the like, for example and grasp the marketing, the use state, and the like.

It is assumed that when the person who performs the analysis, such as the business operator who does marketing on the content, does marketing on predetermined content, the person considers that it is necessary to collect the log data in more detail for the time period from 0 o'clock to 3 o'clock for the terminals belonging to the third class. In addition, it is assumed that the person considers that it is not very necessary to collect the log data in the time period from 3 o'clock to 6 o'clock for the terminals belonging to the third class. In such a case, the person who performs the analysis can cause the display of the log analysis apparatus 31 or the like to display the GUI which is not shown in the drawing and request for the change in the parameter setting so as to change the content of the log collection.

For example, when the change in the parameter setting is requested by the log analysis apparatus 31, the request is received by the request obtaining control unit 334 of the log collection server 27 request obtaining control unit 334. Then, the request obtaining control unit 334 generates the information or the like for specifying the parameter to be changed and supplies the information or the like to the instruction data generation unit 335.

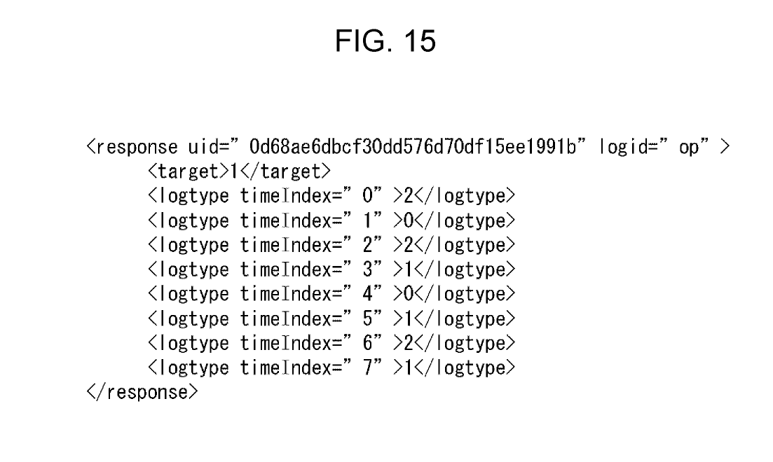

For example, the terminal sorted to the third class is specified by the request obtaining control unit 334, and the information for generating the instruction data which instructs the content of the log for each time period for such terminals is supplied. Accordingly, the instruction data shown in FIG. 15 is generated by the instruction data generation unit 335.

In the example of FIG. 15, the XML text for instructing the change of the parameter setting is generated as the instruction data. In the XML text in the drawing, the identification number (the attribute “uid” in FIG. 9) of the terminal which transmits the instruction data is designated with the tag described as “<response uid=“0d68ae6dbcf30dd576d70df15ee1991b” logid=“op”>”. Here, the instruction data is made to be included in the response to the polling of the terminal corresponding to the designated “uid”. In the XML text in the drawing, the terminal is designated as the target of the log collection with the tag described as “<target>1</target>”.

Moreover, the content of the data to be included in the log data collected in each time period is designated by the description thereafter in the XML text in FIG. 15. Here, it is assumed that the time period for the log collection is sorted into eight time periods including “0 to 3”, “3 to 6”, “6 to 9”, . . . “21 to 24” at intervals of three hours, and the numbers from 0 to 7 are allotted to each of the eight time periods for identifying the time period. For example, the time period with the number of 0 is “0 to 3”, the time period with the number of 1 is “3 to 6”, . . . and the time period with the number of 7 is “21 to 24”.

In addition, the numbers from 0 to 2 are allotted in order to identify the content of data to be included in the collected log data. For example, in the case of the number 0, only the identification number of the terminal and the time stamp are included in the log data. In the case of the number 1, the information indicating the type of the operation when the event occurs is also included in the log data. In the case of the number 2, the identification number for specifying the content being displayed on the display of the terminal 21 when the event occurs is also included in the log data.

For example, in the XML text in FIG. 15, designation is made with the tag described as “<logtype timeIndex=“0”>2</logtype>” such that the identification number of the terminal, the time stamp, the type of the operation when the event occurs, and the identification of the content when the event occurs are made to be included in the log data and transmitted for the time period of “0 to 3”. In addition, the designation is made with the tag described as “<logtypetimeIndex=“1”>0</logtype>” such that only the identification number of the terminal and the stamp are made to be included in the log data and transmitted for the time period of “3 to 6”.

In the same manner, the content of the data to be included in the log data collected even in the time period thereafter is also designated in the same manner.

Such instruction data is generated for each of the terminals sorted to the third class by the instruction data generation unit 335. For example, the request obtaining control unit 334 specifies the identification number of each of the terminals sorted to the third class based on the sorting result by the log data sorting unit 333, the description of the tag for designating the identification number of the terminal is changed, and the instruction data as shown in FIG. 15 is respectively generated.

As described above, it is possible to set the frequency, at which the information (log content) to be included in the log data or the log data is transmitted to the log collection server, as the parameter according to this technique. In addition, it is possible to feed back the changed parameter to all log collection target terminals via the log collection server. That is, the parameter is fed back to the log collection target terminal in response to the request of the user (the person who performs the analysis) of the log analysis apparatus.

As the amount of the log data increases, it takes more time to process the data, and it becomes difficult to complete the desired analysis within a unit time. In addition, the increased data amount increases the costs for maintaining and managing the data.

Moreover, if the logs which can be collected from each device are uniformly collected as in the log collection according to the technique in the related art, the burden of the log collection is placed on all users. For example, the burden of battery consumption of the device, the security risks, and the like is placed on the user, for example.

In the log collection in the related art, the addition of functions relating to the log collection and the like is performed in accordance with the timing of the upgrading of the application program of the device, for example. When the log analysis is performed for the purpose of marketing or the like, however, speed is an important factor, when it becomes necessary to add the information which has not yet been transmitted to the log data for the log analysis.

Moreover, since the system relating to the log collection and the system relating to the log analysis employ systems which are independent from each other, for example, adjustment for the addition of the log content, the change in the frequency of the log collection, and the like tend to become more complicated.

On the other hand, this technique is configured such that the changed parameter can be fed back to all log collection target terminals via the log collection server as described above. That is, since it is possible to change the transmission frequency and the content of the log data in accordance with the purpose, it is possible to collect the minimum requisite log data to achieve the purpose. Accordingly, the amount of the log data to be processed does not become huge, and it becomes possible to perform sufficient log analysis.

In addition, this technique is configured such that the parameter can be fed back to the log collection target terminals without waiting for the timing of the upgrading of the application program. Therefore, it is possible to implement marketing at a high speed.

Moreover, this technique is configured such that the feed-back is reflected by the instruction described by an XML text, for example. Accordingly, it is possible to perform the addition of the log content, the change in the frequency of the log collection, and the like without performing the complicated adjustment between the persons involved.

According to this technique, it is possible to change the data content to be included in the log data and the collection frequency as the result of the first analysis of the collected log, and it is also possible to further change the data content to be included in the log data and the collection frequency after the analysis result of the logs collected after the change. That is, this technique makes it possible to dynamically perform the log analysis in accordance with the use purpose of the terminal by the user, the change in the use time, and the like, for example.

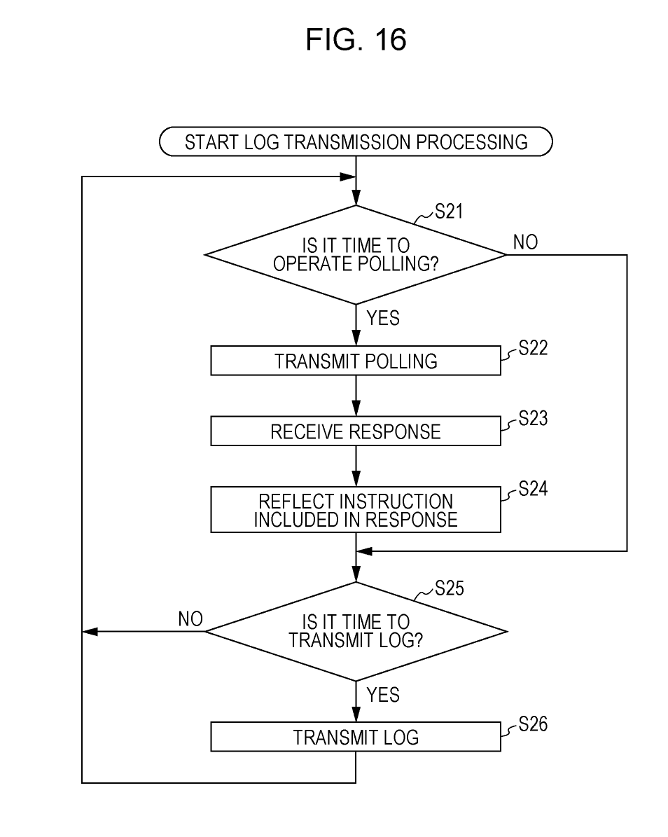

Next, an example of the log transmission processing by the terminal 21 in FIG. 3 will be described with reference to the flowchart in FIG. 16. In addition, description will be given here of an example of the log transmission processing by the terminal 21 and the same log transmission processing is performed in the terminal 22, the terminal 23, . . . as well.

In Step S21, the polling control unit 303 of the terminal 21 determines whether it is time to perform the polling. If it is determined that it is time to perform the polling in Step S21, the processing proceeds to Step S22.

In Step S22, the polling control unit 303 performs the polling on the log collection server 27.

In Step S23, the polling control unit 303 receives the response to the polling in Step S22. Here, if the feed-back is included in the response to the polling from the log collection server 27, the polling control unit 303 supplies the information relating to the feed-back to the feed-back control unit 304.

In Step S24, the feed-back control unit 304 reflects the instruction (feed-back) included in the response. Here, the feed-back control unit 304 reads the information relating to the feed-back and reflects the designated parameter setting, for example. In so doing, the data described as an XML text is read as the information relating to the feed-back, and the parameter setting is changed in accordance with the description of the XML text.

Thereafter, the log data generation unit 305 generates the log data based on the changed parameter.

If it is determined that it is not time to perform the polling in Step S21, the processing from Step S22 to Step S24 is skipped, and the processing proceeds to Step S25.

In Step S25, the log data transmission unit 306 determines whether or not it is time to transmit the log data. If it is determined that it is not time to transmit the log data yet in Step S25, the processing returns to Step S21. On the other hand, if it is determined that it is time to transmit the log data in Step S25, the processing proceeds to Step S26.

In Step S26, the log data transmission unit 306 transmits the log data generated by the log data generation unit 305 to the log collection server 27 based on the set parameter. Then, the processing returns to Step S21.

As described above, the log transmission processing is executed.

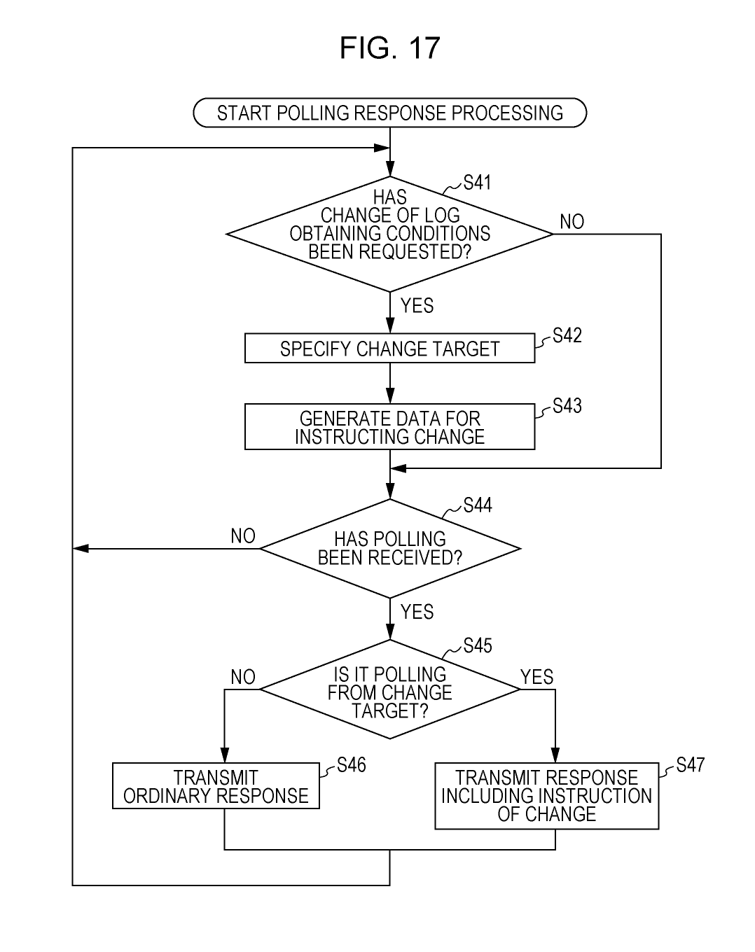

Next, description will be given of an example of the polling response processing by the log collection server 27 in FIG. 3 with reference to the flowchart in FIG. 17.

In Step S41, the request obtaining control unit 334 of the log collection server 27 determines whether or not the change in the log obtaining conditions, namely the change in the aforementioned setting from the log analysis apparatus 31 has been requested. If it is determined that the change in the parameter setting has been requested in Step S41, the processing proceeds to Step S42.

In Step S42, the request obtaining control unit 334 specifies the terminal (the change target) as the target of the change in the parameter. For example, the identification number of each change target is specified.

In Step S43, the instruction data generation unit 335 generates the instruction data for each of the change targets specified in Step S42. At this time, the instruction data as described above is generated with reference to FIGS. 13 and 15, for example.

After the processing in Step S43, the processing proceeds to Step S44. If it is determined that the change in the parameter setting has not been requested in Step S41, the processing in Step S42 and Step S43 is skipped, and the processing proceeds to Step S44.

In Step S44, the polling control unit 331 of the log collection server 27 determines whether or not the polling from the terminal 21 or the like has been received. If it is determined that the polling has not been received in Step S44, the processing returns to Step S41. If it is determined that the polling has been received in Step S44, the processing proceeds to Step S45.

In Step S45, the polling control unit 331 determines whether the polling which has been determined to be received in Step S44 is the polling from the change target specified in Step S42. If it is determined that the polling is not the polling from the change target in Step S45, the processing proceeds to Step S46.

In Step S46, the polling control unit 331 transmits the ordinary response as the response to the polling.

On the other hand, if it is determined that the polling is the polling from the change target in Step S45, the processing proceeds to Step S47.

In Step S47, the polling control unit 331 transmits the response including the instruction data generated by the processing in Step S43 as the response to the polling.

After the processing in Step S46 or Step S47, the processing returns to Step S41.

In so doing, the polling response processing is executed.

By employing such a log collection system 10, it is possible to implement marketing as follows, for example.

For example, a case will be considered in which a film distributing company does marketing for the effective advertisement for a movie to be released one month later.

For example, the person in charge of the marketing in the film distributing company uses the log analysis apparatus 31 or the like to obtain and analyze the log data of the terminals which have accessed the web page of the company. It is assumed that it is known as a result of the analysis that many terminals access the web page of the company after visiting the web page of a certain search engine. The person in charge of the marketing in the film distributing company uses the log analysis apparatus 31 or the like to further specify the time period at which the terminals access the web page of the company with a high frequency. It is assumed that it is known as a result of the analysis that the frequency at which each terminal accesses the web page of the company is high in the time period from 6 o'clock to 9 o'clock and the time period from 18 o'clock to 21 o'clock.

In such a case, the display of banner advertising in the time period from 6 o'clock to 9 o'clock and the time period from 18 o'clock to 21 o'clock in the web page of the certain search engine is effective for the film distributing company, for example. That is, it is possible to sufficiently enhance the effect of the advertisement at low cost.

By employing such a log collection system 10, it is possible to realize the following contact scheme.

For example, when there is a concern about the flooding of a river due to heavy rain, and it is necessary to issue an evacuation order to the adjacent neighborhood, as many terminals positioned near the river are specified as possible, and the highest-traffic web page of the terminals is specified. Then, a message “The river XX is expected to overflow. Please evacuate immediately.” is displayed on the web page, for example.

In so doing, it is possible to expect that the information is delivered through word of mouth from each user who has accessed the web page, for example.

In addition, the aforementioned series of processing can be executed by the hardware or the software. When the aforementioned series of processing is executed by the software, a program constituting the software is installed from a network or a recording medium to a computer incorporated in the dedicated hardware. Alternatively, the program is installed from a network or a recording medium to a general personal computer which is capable of executing various functions by installing various programs.

When the aforementioned series of processing is executed by the software, the program constituting the software is installed from a network such as the Internet or the recording medium such as a removable medium or the like.

The aforementioned series of the processing in this specification include not only the processing performed in the time series manner in the described order but also the processing executed in a parallel manner or in an individual manner, and the processing is not necessarily performed in the time series manner.

The embodiments of the present disclosure are not limited to the aforementioned embodiments, and various modifications can be made within the scope of the present disclosure.

For example, the present technology can adopt the following configurations.

(1) An information processing apparatus comprising:

a polling receiving unit which receives polling from a plurality of terminals which performs communication via a network;

a change necessity determination unit which determines whether or not the terminal which has transmitted the received polling is a terminal for which it is necessary to change parameter setting relating to log data collection; and

an instruction data transmission unit which transmits instruction data, which instructs the terminal to change the parameter setting relating to the log data collection, as a response to the polling when it is determined that the terminal which has transmitted the received polling is the terminal for which it is necessary to change the parameter setting relating to the log data collection.

(2) The information processing apparatus according to the (1), further comprising:

a database which receives and accumulates the log data transmitted from the terminal,

wherein the log data accumulated in the database is supplied to a plurality of log analysis apparatuses in response to requests from the plurality of log analysis apparatuses connected via a network.

(3) The information processing apparatus according to the (1), further comprising:

a change request receiving unit which receives requests for the change in the parameter setting relating to the log data collection from a plurality of log analysis apparatuses,

wherein the change necessity determination unit specifies a terminal as a target of change in the request for the change in the parameter setting relating to the log data collection from the log analysis apparatus and determines whether or not the terminal which has transmitted the received polling is the specified terminal.

(4) The information processing apparatus according to the (1),

wherein the instruction data transmission unit transmits instruction data which is for changing a frequency at which the terminal transmits the log data to the information processing apparatus.

(5) The information processing apparatus according to the (1),

wherein the instruction data transmission unit transmits instruction data which is for changing data content included in log data transmitted by the terminal to the information processing apparatus.

(6) An information processing method comprising:

causing a polling receiving unit to receive polling from a plurality of terminals which performs communication via a network;

causing a change necessity determination unit to determine whether or not the terminal which has transmitted the received polling is a terminal for which it is necessary to change parameter setting relating to log data collection; and

causing an instruction data transmission unit to transmit instruction data, which instructs the terminal to change the parameter setting relating to the log data collection, as a response to the polling when it is determined that the terminal which has transmitted the received polling is the terminal for which it is necessary to change the parameter setting relating to the log data collection.

(7) An electronic device comprising:

an event detection unit which detects occurrence of an event;

a log recording control unit which controls recording of the information relating to the detected event as logs;

a polling transmission unit which transmits polling to a log collection server at a preset time;

a setting change unit which obtains instruction data included in a response to the polling which has been transmitted from the log collection server and changes a parameter setting relating to log data collection based on the instruction data; and

a log data transmission unit which transmits the log data generated by extracting the logs to the log collection server based on a parameter whose setting has been changed.

(8) A control method of an electronic device comprising:

causing a polling transmission unit to transmit polling to a log collection server at a preset time;

causing a setting change unit to obtain instruction data included in a response to the polling which has been transmitted from the log collection server and change parameter setting relating to log data collection based on the instruction data; and

causing a log data transmission unit to transmit the log data generated by extracting the logs recording information relating to an event detected in advance to the log collection server based on a parameter whose setting has been changed.

(9) A log collection system comprising:

a log collection server; and

an electronic device,

wherein the log collection server includes

a polling receiving unit which receives polling from a plurality of electronic devices which perform communication via a network,

a change necessity determination unit which determines whether or not the electronic device which has transmitted the received polling is an electronic device for which it is necessary to change parameter setting relating to log data collection, and

an instruction data transmission unit which transmits instruction data, which instructs the electronic device to change the parameter setting relating to the log data collection, as a response to the polling when it is determined that the electronic device which has transmitted the received polling is an electronic device for which it is necessary to change the parameter setting relating to the log data collection,

wherein the electronic device includes

an event detection unit which detects occurrence of an event,

a log recording control unit which controls recording of the information relating to the detected event as logs,

a polling transmission unit which transmits polling to a log collection server at a preset time,

a setting change unit which obtains instruction data included in a response to the polling which has been transmitted from the log collection server and changes a parameter setting relating to log data collection based on the instruction data, and

a log data transmission unit which transmits the log data generated by extracting the logs to the log collection server based on a parameter whose setting has been changed.

The present disclosure contains subject matter related to that disclosed in Japanese Priority Patent Application JP 2011-073043 filed in the Japan Patent Office on Mar. 29, 2011, the entire contents of which are hereby incorporated by reference.

What is claimed is:

1. An apparatus for instructing changes relating to log data collection via a network associated with a plurality of terminals, the apparatus comprising:
a communication unit;
at least one memory to store processor-executable instructions; and
a processing unit communicatively coupled to the communication unit and the at least one memory, wherein upon execution of the processor-executable instructions by the processing unit, the processing unit:
determines that a parameter setting for log data collection should be changed for a first terminal of the plurality of terminals; and
in response to receiving a signal from the first terminal at the communication unit, controls the communication unit to transmit instruction data to the first terminal to change the parameter setting for log data collection.

2. The apparatus of claim 1, wherein:
the communication unit receives log data from the first terminal; and
the parameter setting for log data collection is based on information in the received log data.

3. The apparatus of claim 2, wherein the parameter setting for log data collection is based on a group to which the first terminal is assigned based on information in the received log data.

4. The apparatus of claim 3, wherein the information in the received log data indicates a frequency of usage of the first terminal.

5. The apparatus of claim 3, wherein the information in the received log data indicates a frequency of lock release of the first terminal.

6. The apparatus of claim 2, wherein the parameter setting for log data collection controls a frequency of log data transmission by the first terminal.

7. The apparatus of claim 2, wherein the parameter setting for log data collection controls a content of log data transmitted by the first terminal.

8. The apparatus of claim 1, wherein each of the plurality of terminals is assigned to a group based on log data indicating its frequency of usage, and a parameter setting is assigned to each of the plurality of terminals based on the group to which it is assigned.

9. A method of instructing changes relating to log data collection via a network associated with a plurality of terminals, the method comprising:
determining that a parameter setting for log data collection should be changed for a first terminal of the plurality of terminals;
electronically receiving a signal from the first terminal; and
in response to electronically receiving the signal, electronically transmitting instruction data to the first terminal to change the parameter setting for log data collection.

10. The method of claim 9, further comprising:
electronically receiving log data from the first terminal;
wherein the parameter setting for log data collection is based on information in the received log data.

11. The method of claim 10, wherein the parameter setting for log data collection is based on a group to which the first terminal is assigned based on information in the received log data.

12. The method of claim 11, wherein the information in the received log data indicates a frequency of usage of the first terminal.

13. At least one computer-readable medium encoded with instructions that, when executed on at least one processing unit, cause an apparatus to:
determine that a parameter setting for log data collection should be changed for a first terminal of a plurality of terminals;
electronically receive a signal from the first terminal; and
in response to electronically receiving the signal, electronically transmit instruction data to the first terminal to change the parameter setting for log data collection.

14. The least one computer-readable medium of claim 13, wherein the parameter setting for log data collection is based on information in log data received from the first terminal.

15. The least one computer-readable medium of claim 14, wherein the parameter setting for log data collection is based on a group to which the first terminal is assigned based on information in the received log data.

16. The least one computer-readable medium of claim 15, wherein the information in the received log data indicates a frequency of usage of the first terminal.

17. An apparatus for receiving instructions relating to log data collection via a network associated with a server, the apparatus comprising:
a communication unit;
at least one memory to store processor-executable instructions; and
a processing unit communicatively coupled to the communication unit and the at least one memory, wherein upon execution of the processor-executable instructions by the processing unit, the processing unit:
controls the communication unit to transmit a signal to the server; and
in response to receiving a response to the signal, the response comprising instruction data to change a parameter setting for log data collection, changes the parameter setting for log data collection.

18. The apparatus of claim 17, wherein the processing unit:
further controls the communication unit to transmit log data to the server;
wherein the parameter setting for log data collection is based on information in the transmitted log data.

19. The apparatus of claim 18, wherein the parameter setting for log data collection is based on a group to which the first terminal is assigned based on information in the transmitted log data.

20. The apparatus of claim 19, wherein the information in the transmitted log data indicates a frequency of usage of the first terminal.
